(19) United States
(12) Patent Application Publication
(10) Pub. No.: US 2020/0090319 A1
(43) Pub. Date: Mar. 19, 2020

(54) MACHINE LEARNING METHOD IMPLEMENTED IN AOI DEVICE

(71) Applicant: HONGFUJIN PRECISION ELECTRONICS (TIANJIN) CO.,LTD., Tianjin (CN)

(72) Inventors: MING-KUEI LIAO, Singapore (SG); QIAO-ZHONG ZHAO, Tianjin (CN); YI-TING LIU, New Taipei (TW)

(21) Appl. No.: 16/256,729

(22) Filed: Jan. 24, 2019

(30) Foreign Application Priority Data
Sep. 19, 2018 (CN) 201811095927.2

(51) Int. Cl. G06T 7/00; G06K 9/32; G06K 9/62; G06N 20/00

(52) U.S. Cl. CPC G06T 7/0002; G06N 20/00; G06K 9/6263; G06K 9/3233

(57) ABSTRACT

A machine learning method is used for improving accuracy of an automated optical inspection (AOI) device. The method includes obtaining an image of a component to be inspected, processing the image to generate digital image information, establishing a machine learning model according to the digital image information, inputting the digital image information into the machine learning model for determination, verifying accuracy of a result of determination by the machine learning model, adjusting and optimizing the machine learning model according to the result of determination of the accuracy of the machine learning model, and improving the machine learning model until the machine learning model reaches a predetermined accuracy.

### FIELD

The subject matter herein generally relates to machine learning methods, and more particularly to a machine learning method implemented in an automated optical inspection (AOI) device.

### BACKGROUND

During a production process, automated optical inspection (AOI) equipment is generally used to inspect manufactured circuit board. With improvements in technology, a size of resistors and capacitors on the circuit board becomes smaller and smaller, and due to limitations of specifications of AOI equipment, a false positive rate of the AOI equipment is increased.

### BRIEF DESCRIPTION OF THE DRAWINGS

Implementations of the present disclosure will now be described, by way of example only, with reference to the attached figures.

FIG. 1 is a flowchart of a first embodiment of a machine learning method.

FIG. 2 is a flowchart of a method of processing an image in the machine learning method in FIG. 1.

FIG. 3 is a flowchart of a method of verifying a result of determination in the machine learning method in FIG. 1.

FIG. 4 is a flowchart of a second embodiment of a machine learning method

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain components may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

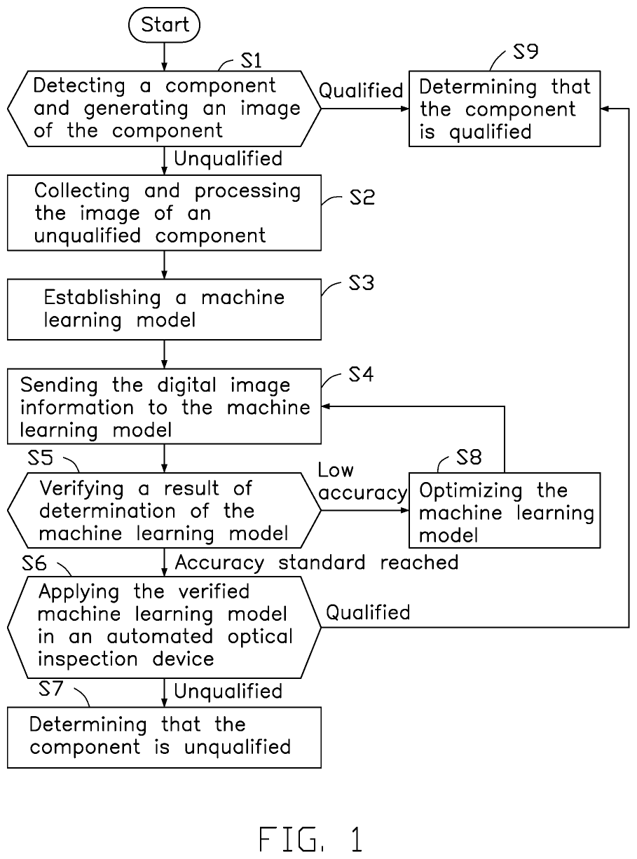

FIGS. 1-3 show a first embodiment of a machine learning method for improving accuracy of an Automatic Optic Inspection (AOI) device.

At block S1, the AOI device detects a component and generates an image of the component. If the image of the component is determined to be qualified, block S8 is implemented. If the image of the component is determined to be unqualified, block S2 is implemented.

At block S2, the image of the unqualified component is collected and processed. Block S2 may be performed by a processor (not shown) of the AOI device or other device having similar functions.

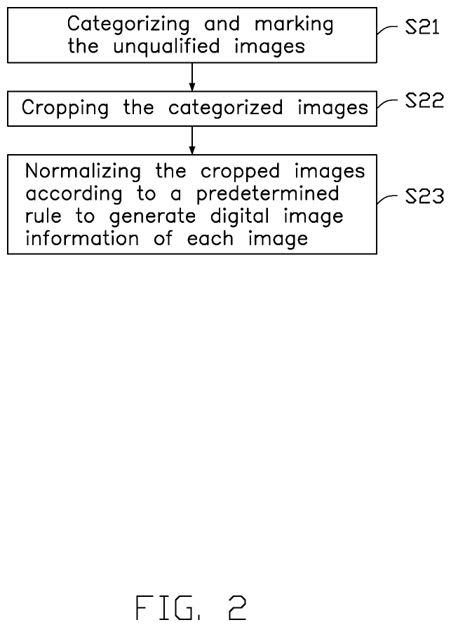

As shown in FIG. 2, at block S21, the unqualified images are first categorized and marked. The unqualified images include foreign objects, wrong components, missing components, offset components, reverse components, damaged components, or the like. At block S22, the categorized images are cropped to a predetermined size, and irrelevant portions of the images are removed, such that the component to be inspected is positioned in a center of the image. At block S23, the cropped images are normalized according to a predetermined rule to form digital image information of each image. In one embodiment, RGB values of each pixel in the image are respectively stored in three matrices, and then each RGB value in each matrix in a range from 0-255 is normalized to a value between 0 and 1. After all the images are processed, block S3 is implemented.

At block S3, a machine learning model is established according to characteristics of categorization marks of the digital image information by Convolutional Neural Network (CNN) technology. The machine learning model is established and stored as a computer programming language such as Python, Tensorflow, and Keras in a computer storage media. CNN includes a convolutional layer, a maximum pooling layer, and a fully connected layer. The convolutional layer cooperates with the largest pooling layer to form multiple convolution groups, extracting features layer by layer, and finally classifying through the fully connected layer, thereby realizing an image identification function. When the CNN has more layers, the machine learning model has a higher accuracy. In one embodiment, the CNN of the machine learning model includes at least four convolution layers, at least four maximum pooling layers, and at least two fully connected layers, which effectively ensures accuracy of determination of the machine learning model.

At block S4, the digital image information obtained in block S2 is sent to the machine learning model for training and testing the machine learning model, and letting the machine learning model determine whether the component is unqualified or the component was marked unqualified by error.

In order to increase accuracy of determination by the machine learning model, a large number of component images need to be collected in blocks S1 and S2 for training and testing the machine learning model. In addition, improving hardware of the AOI device and improving sharpness of the images are also beneficial to improve the accuracy of the machine learning model.

At block S5, a result of determination of the machine learning model is verified. If the accuracy of the machine learning model reaches a predetermined standard, block S6 is implemented. Otherwise, if the accuracy of the machine learning model does not reach the predetermined standard, block S8 is implemented, the machine learning model is optimized and adjusted, and then blocks S4, S5, and S8 are repeated until the accuracy of the machine learning model reaches the predetermined standard.

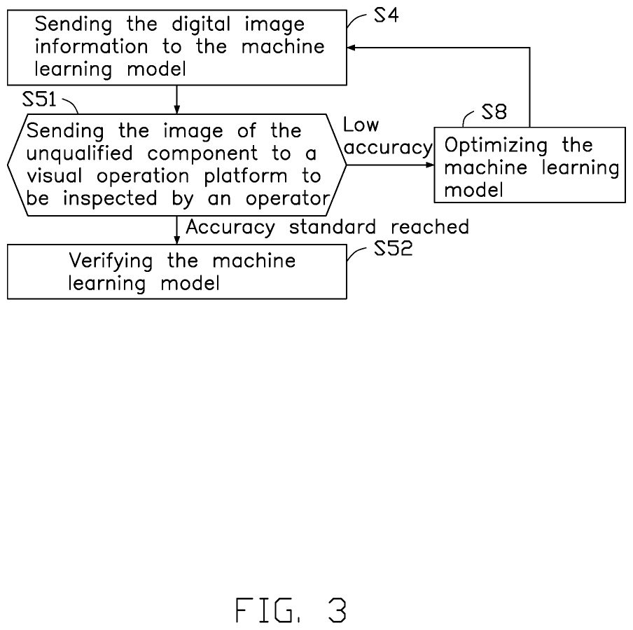

As shown in FIG. 3, at block 551, the image of the component that the machine learning model determines to be unqualified is sent to a visual operation platform of the AOI device, and the image of the machine learning model is inspected by an operator. The result of determination by the machine learning model is compared to a result of determination by the operator, and the accuracy of the machine learning model is calculated. If the accuracy of the machine learning model is lower than a predetermined value, such as 99.99%, it is determined that the result of determination by the machine learning model is inconsistent with the result of determination by the operator, and block S8 is implemented. If the accuracy of the machine learning model reaches the predetermined standard, that is, the accuracy rate is greater than or equal to the predetermined value, it is determined that the result of determination by the machine learning model is consistent with the result of determination by the operator, and block S52 is implemented, and the machine learning model is stored in the AOI device.

At block S6, the verified machine learning model is applied in the AOI device, an image of a next component to be inspected is obtained from the AOI device, and the image of the next component to be inspected is processed to obtain new digital image information. The new digital image information is input to the machine learning model. The machine learning model determines whether the next component to be inspected is unqualified. If the result of determination is qualified, block S9 is implemented. If the result of determination is unqualified, block S7 is implemented, and the unqualified component is disposed. In an initial stage of application of the machine learning model in the AOI equipment, the accuracy of the machine learning model can be repeatedly confirmed by an operator. After the accuracy of the machine learning model is verified, the operator can be replaced by the machine learning model.

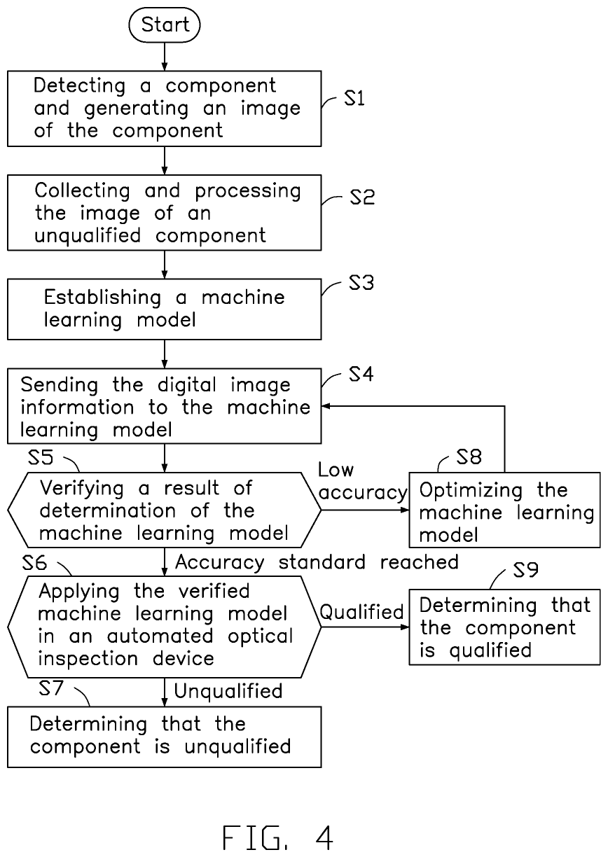

FIG. 4 shows a second embodiment of the machine learning method. A difference between the second embodiment and the first embodiment is that in block S1, after the image of the component is obtained, block S2 is directly implemented.

At block S2, the components of the images are divided into two categories of qualified and unqualified, and then the images are preprocessed to generate the digital image information. Step S3 is based on the newly created machine learning model according to the digital image information, and then in block S4, the machine learning model determines a result of the preprocessed image to implement training on the machine learning model. Then, the result of determination by the machine learning model is sent to block S5 for verification. According to the verification result, it is determined whether it is necessary to proceed to block S8 to optimize the machine learning model. After the machine learning model is verified, the machine learning method proceeds to block S6, and the machine learning model is applied to the AOI device. The images of the next component to be inspected obtained from the AOI device are preprocessed and then determined by the machine learning model to be qualified or unqualified. If the result of determination is qualified, block S9 is implemented. If the result of determination is unqualified, block S7 is implemented, and the unqualified component is disposed.

The machine learning method provided by the present disclosure uses the machine learning model to continuously determine a result of the images of the components detected by the AOI device and replace the operator, which greatly reduces a false positive rate of the AOI device and labor intensity of the operator.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the components within the principles of the present disclosure up to, and including, the full extent established by the broad general meaning of the terms used in the claims.

What is claimed is:

1. A machine learning method for improving accuracy of an automated optical inspection (AOI) device, the method comprising:
obtaining an image of a component to be inspected;
processing the image to generate digital image information;
establishing a machine learning model according to the digital image information;
inputting the digital image information into the machine learning model for determination;
verifying accuracy of a result of determination by the machine learning model; and
adjusting and optimizing the machine learning model according to the result of determination of the accuracy of the machine learning model; wherein
above process is repeated until the machine learning model reaches a predetermined accuracy.

2. The method of claim 1, wherein the step of processing the image comprises:
cropping the image to a predetermined size to center the component in the image; and
standardizing a pixel value of each pixel of the image according to a predetermine rule to generate the digital image information.

3. The method of claim 1, wherein the step of verifying accuracy of a result of determination by the machine learning model comprises:
sending pictures determined by the machine learning model to be unqualified to a platform for visual inspection by an operator; and
comparing a result of determination by the operator to the result of determination by the machine learning model.

4. The method of claim 3, wherein the step of adjusting and optimizing the machine learning model according to the result of determination of the accuracy of the machine learning model comprises:
adjusting and optimizing the machine learning model if the result of determination by the machine learning model is not the same as the result of determination by the operator; and
verifying the accuracy of the result of determination by the machine learning model if the result of determination by the machine learning model is the same as the result of determination by the operator.

5. The method of claim 4 further comprising:
saving the machine learning model to the AOI device after the machine learning model is verified.

6. The method of claim 1, wherein:
the machine learning model is established by a convolutional neural network.

7. The method of claim 6, wherein:
the machine learning model comprises at least four convolution layers, at least four maximum pooling layers, and at least two fully connected layers.

8. The method of claim 1, wherein the machine learning model is established by:
establishing a corresponding machine learning model for each kind of component.

9. The method of claim 1 further comprising:
implementing the machine learning model in the AIO device;
obtaining an image of a next component to be inspected;
processing the image of the next component to be inspected to generate digital image information; and
inputting the digital image information of the image of the next component to be inspected into the machine learning model for determination.
